(19) United States
(12) Patent Application Publication
(10) Pub. No.: US 2022/0185991 A1
(43) Pub. Date: Jun. 16, 2022

(54) FLAME RETARDANT POLYAMIDES AND COPOLYAMIDES FOR 3D PRINTING

(71) Applicant: Arkema France, Colombes (FR)

(72) Inventors: Jean-Jacques FLAT, Serquigny (FR); Benoît BRULE, Serquigny (FR); Ornella ZOVI, Serquigny (FR); Jean-Charles DURAND, Serquigny (FR)

(73) Assignee: Arkema France, Colombes (FR)

(21) Appl. No.: 17/439,865

(22) PCT Filed: Mar. 17, 2020
(86) PCT No.: PCT/FR2020/050581

§ 371 Date: Sep. 16, 2021

(30) Foreign Application Priority Data
Mar. 18, 2019 (FR) 1902769

(51) Int. Cl. C08K 5/5357

(52) U.S. Cl. CPC C08K 5/5357; C08K 5/0066

(57) ABSTRACT

Process for the preparation of flame-retarded parts by powder bed fusion, in which the powder comprises at least one polyamide and at least one flame-retardant agent of cyclic phosphonate ester type.

### SUBJECT MATTER OF THE INVENTION

The present invention relates to a process for the preparation of flame-retarded parts by powder bed fusion, in which the powder comprises at least one polyamide and/or copolyamide and at least one flame-retardant agent and also to the corresponding powder.

### TECHNICAL BACKGROUND

The main industrial challenges for the production of flame-retarded polyamide or copolyamide powders which can be employed by any powder bed fusion technology, in particular layer-by-layer for additive manufacturing, can be summarized as four points, namely:
(i) achieving the required level of fire resistance at a lower cost:
(ii) coming within the context of sustainable development in particular with environmentally friendly flame-retardant additives:
(iii) retaining, as much as possible, the mechanical properties of the polyamide; and
(iv) obtaining good processability of these materials in 3D machines.

The flame retardancy of polymers is conventionally provided by the dispersion of mineral fillers or flame-retardant additives, in particular based on halogenated compounds.

However, the majority of these compounds used, which are nevertheless very effective, are subject to various regulations limiting, indeed even banning, in the long run, their use as a result of harmful environmental impacts or of their toxicity.

In this context novel nonhalogenated systems have been developed, such as compounds based on phosphorus, on nitrogen or on inorganic compounds.

Thus, the patent application US 2010/0324190 for its part describes a powder comprising polyamide 12 and a flame-retardant additive of ammonium polyphosphate type, as well as its use in 3D printing. However, ammonium polyphosphate is responsible for a sign flea nt uptake of water by the parts which contain it, which is harmful to their dimensional stability in the event of variation in the humidity level.

In order to satisfy the needs for flame-retarded polyamide powders, it thus remains necessary to find other alternatives to these flame-retardant additives.

### SUMMARY OF THE INVENTION

The present invention results from the unexpected demonstration, by the inventors, that the addition, to a powder for 3D printing, of a flame-retardant agent of cyclic phosphonate ester type of following formula (III):

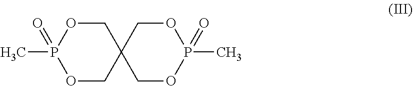

makes it possible to obtain parts of good quality in 3D printing while conferring on them a flame retardancy equivalent to or superior to that obtained according to the state of the art.

It has been observed that the mixture of a powder for 3D printing and the flame-retardant agent of the invention makes it possible to obtain well-sintered flame-retarded parts which do not exhibit a coalescence problem, thus guaranteeing good mechanical properties.

The present invention relates to a process for the preparation of flame-retarded parts by powder bed fusion, in which the powder comprises at least one polyamide and/or copolyamide and at least one flame-retardant agent of cyclic phosphonate ester type.

The present invention also relates to a powder intended for the preparation of flame-retarded parts by powder bed fusion, comprising at least one polyamide and/or copolyamide and at least one flame-retardant agent of cyclic phosphonate ester type.

The present invention also relates to the use of a powder comprising at least one polyamide and/or copolyamide and at least one flame-retardant agent of cyclic phosphonate ester type in a powder bed fusion process, in particular a 3D printing process, more particularly a process for 3D printing by laser or Infrared sintering, in order to produce a flame-retarded part.

The present invention also relates to a process for the preparation of a powder as defined above, comprising the mixing of at least one polyamide and/or copolyamide and of at least one flame-retardant agent of cycle phosphonate ester type.

### DETAILED DESCRIPTION OF THE INVENTION

### Powder Bed Fusion

As understood here, a process by powder bed fusion is on additive manufacturing process in which an object or a part is obtained by the selective fusion of certain regions of a bed of powder according to the invention.

Preferably, the process according to the invention is a 3D printing process and the powder is a powder for 3D printing. More preferably, the process according to the invention is a process for 3D printing by laser or infrared sintering of the powder. The term “3D printing” or “additive manufacturing”, within the meaning of the invention, is understood to mean any process for the volume manufacturing of parts by addition or agglomeration of powder, layer by layer. The agglomeration of powders by melting (hereinafter “sintering”) is brought about by radiation, such as, for example, a laser beam (laser sintering). Infrared radiation. UV radiation, or any source of electromagnetic radiation which makes it possible to melt the powder layer by layer in order to manufacture three-dimensional objects. The technology for the manufacture of objects layer by layer b described in particular in the patent application WO 2009/138692 (pages 1 to 3).

Within the meaning of the invention, the term “3D printing” or “additive manufacturing” is also understood to mean selective sintering technologies using an absorber, in particular the technologies known under die names “High Speed Sintering” (HSS) and “Multi-Jet Fusion” (MJF), in these technologies, the 3D manufacture of objects is also carried out layer by layer starting from a digital file, the process using a powder (for example a polymer) which is melted in a controlled manner for each layer constituting the 3D object: an absorber is deposited on the layer (by means, for example, of a liquid ink in the “inkjet process”) before the exposure of the layer to electromagnetic radiation (for example Infrared radiation) which brings about melting of the regions containing said absorber. For example, the patent documents U.S. Pat. No. 9,643,359 and EP1 648 686 describe such processes. 3D printing is generally used to produce prototypes, models of parts (“rapid prototyping”) or to produce functional parts in small series (“rapid manufacturing”), for example in the following fields: automobile, nautical, aeronautical, aerospace, medical (prostheses, hearing systems, cell tissues, and the Ike), textiles, clothing, fashion, decoration, electronic housings, telephony, home automation, computers, lighting, sport, industrial tools.

In the present description, the term ‘sintering’ Includes, all these processes, whatever the type of radiation. Even if, in the text which follows, reference is usually made to the laser sintering process, that which is written for laser sintering is, of course, valid for the other sintering processes.

In sintering processes, it is recommended to use a polyamide for which the difference between the first-heating melting point Tf1 and the crystallization temperature Tc is as great as possible, in order to avoid deformation phenomena, and for which the enthalpy of fusion ΔHf is as high as possible, in order to obtain a good geometrical definition of the manufactured parts. This makes it possible to Increase the window for working with the polyamide powder and to make it much easier to employ it in a sintering process Processes for obtaining such powders are described in particular in the documents FR 2 867 190, FR 2 873 380 and FR 2 930 555. Preferably, the difference Tf1−Tc of the PA powders used in sintering is within the range from 30° C. to 50° C.

For sintering processes, such as laser sintering. It is also preferred to use polyamide powder with the following properties:

The molecular weight of the powder in the solid state is preferably sufficiently low, that is to say with a n inherent viscosity in solution of less than 3, both in order for the melting of the grains not to require too much energy and in order for the inter grain coalescence to be sufficient during the passage of the radiation, so as to obtain an object with the least possible porosity, with good mechanical properties. The inherent viscosity is measured by adapting the standard ISO 307:2007 (measurement temperature at 20° C. instead of 25° C.) using an Ubbelhode tube; the measurement is carried out at 20° C. on a sample of 75 mg at a concentration of 0.5% (w/w) in m-cresol. The inherent viscosity is expressed in (g/100 g)−1 and is calculated according to the following formula:

Inherent viscosity=ln(tₛ/t₀)×1/C, with C=m/p×100,

In which tₛ is the flow time of the solution, t₀ is the flow time of the solvent m is the weight of the sample for which the viscosity is determined and p is the weight of the solvent.

### Polyamide and Copolyamide

Within the meaning of the Invention, the term “polyamide” is understood to mean the condensation products:
of one or more amino acids, such as aminocaproic acid, 7-aminoheptanoic acid, 11-aminoundecanoic acid and 12-aminododecanoic acid, or of one or mere lactams, such as caprolactam, enatholactam and lauryllactam;
of one or more salts or mixtures of diamines, such as hexamethylenediamine, decane diamine, dodecomethylenediamine, meta-xylyenediamine, bis(p-aminocyclohexyi)methane and trimethylhexamethylenediamine, with diacids, such as isophthalic acid, terephthalic acid, adipic acid, azelaic acid, suberic acid, sebacic acid and dodecanedicarboxylic acid. Mention may be made, by way of example of polyamide, of PA 6, PA 66, PA 610, PA 612, PA 1010. PA 1012. PA 11 and PA 12. Mention may be made, as copolyamide according to the Invention, of copolyamides resulting from the condensation of at least two different monomers, for example of at least two different α,ω-aminocarboxylic acids or of two different lactams a of a lactam and of an α,ω-aminocarboxylic acid with different carbon numbers Mention may also be made of copolyamides resulting from the condensation of at least one α,ω-aminocarboxylic acid (or one lactam), at least one diamine and at least one dicarboxylic acid Mention may also be made of copolyamides resulting from the condensation of an aliphatic diamine with an aliphatic dicarboxylic acid and at least one other monomer chosen from aliphatic diamines other than the preceding one and aliphatic diacids other than the preceding one. Mention may be made, as examples of copolyamides, of copolymers of caprolactam and of lauryllactam (PA 6/12), copolymers of caprolactam, of adipic acid and of hexamethylenediamine (PA 6/66), copolymers of caprolactam, of lauryllactam, of adipic add and of hexamethylenediamine (PA 6/12/66), copolymers of caprolactam, of lauryllactam, of 11-aminoundecanoic acid, of azelaic add and of hexamethylenediamine (PA 6/69/11/12), copolymers of caprolactam, of lauryllactam, of 11-aminoundecanoic acid, of adipic acid and of hexamethylenediamine (PA 6/66/11/12), copolymers of lauryllactam, of azelaic acid and of hexamethylenediamine (PA 69/12), copolymers of 11-aminoundecanoic acid, of terephthalic add and of decamethylenediamine (PA11/10T).

The standard NF EN ISO 1874-1:2011 defines a nomenclature for polyamides. The term ‘monomer’ in the present description of polyamide-based powders must be taken with the meaning of “repeat unit”. The case where a repeat unit of the polyamide consists of the combination of a diacid with a diamine is particular. It is considered that it is the combination of a diamine and of a diacid, that is to say tire ‘diamine diacid’, also called “XY” pair, in equimolar amount, which corresponds to the monomer. This Is explained by the fact that individually, the diacid or the diamine is only a structural unit which is not sufficient by itself alone to form a polymer.

Mention may be made, by way of example of diamine X, of aliphatic diamines having from 6 to 18 atoms. It also being possible for diamine X to be aryl and/or saturated cyclic. Mention may be made, by way of examples, of hexamethylenediamine, piperazine, tetramethylenediamine, octamethylenediamine, decamethylenediamine, dodecamethylenediamine, 1,5-diaminohexane, 2,2,4-trimethyl-1>6-diaminohexane, polyol diamines, isophoronediamine (IPO), methylpentamethylenediamine (MPDM), bis(aminocydohexyl)methane (BACM), bis(3-methyl-4-aminocyclohexyl)methane (BMACM), meta-xylylenediamine, bis(p-aminocyclohexyl)methane and trimethylhexamethylenediamine.

Mention may be made, by way of example of diacid (or dicarboxylic acid) Y, of acids having between 4 and 36 carbon atoms. Mention may be made, for example, of adipic acid, sebacic acid, azelaic acid, suberic acid, isophthalic acid, butanedioic acid, 1,4-cyclohexanedicarboxylic acid, terephthalic acid, the sodium or lithium salt of sulfoisophthalic acid, dimerized fatty acids (these dimerized fatty acids have a dimer content of at least 98% and are preferably hydrogenated) and dodecanedioic acid HOOC—(CH₂)₁₀—COOH.

Tire lactam or amino acid monomers are said to be of “Z” type.

Mention may be made, by way of example of lactams, of those having from 3 to 12 carbon atoms on the main ring and which can be substituted. Mention may be made, for example, of β,β-dimethylpropiolactam, α,α-dimethylpropiolactam, amylolactam, caprolactam, capryllactam, enantholactam, 2-pyrrolidone and lauryllactam.

Mention may be made, by way of example of amino acid, of α,ω-amino acids, such as aminocaproic, 7-aminoheptanoic, 11-aminoundecanoic, n-heptyl-11-aminoundecanoic and 12-aminododecanoic acids.

Preferably, the powder comprising a polyamide and/or copolyamide of the invention comprises at least one polyamide and/or copolyamide chosen from polyamides and copolyamides comprising at least one of one following XY or Z monomers: 46, 4T, 56, 59, 510, 512, 513, 514, 516, 518, 536, 6, 69, 610, 612, 613, 614, 616, 618, 636, 6T, 9, 109, 1010, 1012, 1013, 1014, 1016, 1018, 1036, 10T, 11, 12, 129, 1210, 1212, 1213, 1214, 1216, 1218, 1236, 12T, MXD6, MXD10, MXD12, MXD14, and their blends, in particular chosen from PA 11, PA 12, PA 1010, PA 6, PA 6/10, PA 6/12, PA 10/12, PA 11/1010, and their blends.

The polyamide and/or copolyamide according to the invention can be a blend of polyamides and/or copolyamides. Mention may be made, by way of blend, of blends of aliphatic polyamides/copolyamides and of semiaromatic polyamides/copolyamides and blends of aliphatic polyamides and of cycloaliphatic polyamides.

The polyamide and/or copolyamide according to the invention can be a copolymer having polyamide blocks, in particular a copolymer having polyamide blocks and polyether blocks.

The copolymers having polyamide blocks and polyether blocks result from the polycondensation of polyamide blocks having reactive ends with polyether blocks having reactive ends, such as, inter alia:

1) polyamide blocks having diamine chain ends with polyoxyalkylene blocks having dicarboxyl chain ends:

2) polyamide blocks having dicarboxyl chain ends with polyoxyalkylene blocks having diamine chain ends obtained by cyanoethylation and hydrogenation of α,ω-dihydroxylated aliphatic polyoxyalkylene blocks known as polyether diols;

3) polyamide blocks having dicarboxy chain ends with polyether diols, the products obtained being, in this specific case, polyetheresteramides. These copolymers are advantageously used.

The polyamide blocks having dicarboxyl chain ends originate, for example, from the condensation of α,ω-aminocarboxylic acids, lactams or dicarboxylic acids and diamines in the presence of a chain-limiting dicarboxylic acid.

The polyether can, for example, be a polytetramethylene glycol (PTMG). The latter is also known as polytetrahydrofuran (PTHF).

The number-average molar mass of the polyamide blocks is between 300 and 15 000 and preferably between 600 and 5000 g/mol. The molar mass of the polyether blocks is between 100 and 6000 and preferably between 200 and 3000 g/mol.

The polymers having polyamide blocks and polyether blocks can also comprise randomly distributed units. These polymers can be prepared by the simultaneous reaction of the polyether and of the precursors of the polyamide blocks.

For example, polyether did, a lactam (or an α,ω-amino acid) and a chain-limiting diacid can be reacted in the presence of water. A polymer is obtained having essentially polyether blocks and polyamide blocks of very variable length, but also the various reactants which have reacted randomly, which are distributed randomly along the polymer chain.

The polyether diol blocks are either used as is and copolycondensed with polyamide blocks having carboxyl end groups, or they are aminated in order to be converted into polyether diamines and condensed with polyamide blocks having carboxyl end groups. They can also be blended with polyamide precursors and a chain limiter in order to make polymers having polyamide blocks and polyether blocks which have randomly distributed units.

The ratio of the amount of copolymer having polyamide blocks and polyether blocks to the amount of polyamide is advantageously between 1/99 and 15/85 by weight. Preferably, the polyamide and/or copolyamide according to the invention is selected from the group consisting of polyamide 6 (PA 6), polyamide 66 (PA 66), polyamide 610 (PA 610), polyamide 612 (PA 612), polyamide 11 (PA 11) and polyamide 12 (PA 12). More preferably, the polyamide and/or copolyamide according to the Invention is PA 11.

### Flame-Retardant Agent

Preferably, the flame-retardant agent of cyclic phosphonate ester type is of general formula (I):

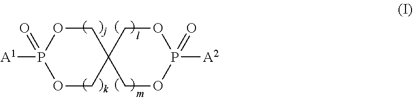

in which:

j, k, l and m, which are identical or different represent an integer from 1 to 3:

A¹ and A², which are identical or different, represent an alkyl group of 1 to 4 carbon atoms or an aryl group of 5 to 7 carbon atoms.

More preferably, the flame-retardant agent of cyclic phosphonate ester type is of general formula (II):

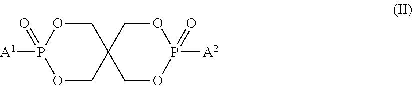

in A¹ and A², which are identical or different, represent an alkyl group of 1 to 4 carbon atoms or an aryl group of 5 to 7 carbon atoms.

More preferably still, the flame-retardant agent of cyclic phosphonate ester type is of following formula (III):

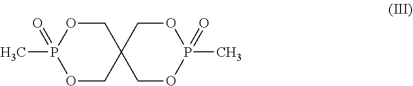

Generally, the fame-retardant agent is a powder, which typically has a volume-median diameter D50 within the range from 1 to 40 μm, preferably from 5 to 30 μm.

### Powder

The powder according to the invention typically as a volume-median diameter D50 Within the range from 5 to 200 μm.

According to one embodiment, the powder has a volume-median diameter D50 within the range from 10 to 150 μm, preferably from 20 to 100 μm, from 25 to 50 μm.

The volume-median diameter (D50) of the powder particles is measured according to the standard ISO 9276—Parts 1 to 6: “Representation of results of particle size analysis”.

The powder can in particular be obtained by mixing the flame-retardant agent of cyclic phosphonate ester type and the at least one polyamide and/or copolyamide. Any method known to a person skilled in the art can be used.

Mention may be made; by way of example, of: the addition of the flame-retardant agent of cyclic phosphonate ester type during the synthesis of the polyamide and/or copolyamide, in particular at the start or at the end of synthesis; mixing by compounding the addition of the flame-retardant agent of cyclic phosphonate ester type during any one stage of a process for the manufacture of powder from said polyamide, in particular by dissolution/precipitation of polyamide in a solvent containing the flame-retardant agent of cyclic phosphonate ester type, for example dispersed or dissolved in the solvent; or by dry blending with the powder.

Preferably, the process for preparation of the powder according to the invention is carried out by a dry blending of the flame-retardant agent and the at least one polyamide and/or copolyamide.

Use may be made, in order to carry out the dry blending, of a blender known to a person skilled in the art, for example a Henschel, Magimix or Loedige blender. The blending is advantageously carried out at ambient temperature. The rotational speed can be easily adjusted.

The powders can optionally be sieved after the blending.

This constitutes an advantageous aspect of the invention, namely the flame-retardant agent in powder form is very easy to disperse in a polyamide powder using a Simple blender of the abovementioned type.

Preferably, the powder comprises from 5% to 40% by weight preferably from 5% to 35% by weight more preferably from 5% to 30% by weight, preferably from 5% to 25% by weight with respect to the total weight of the powder, of the flame-retardant agent of cyclic phosphonate ester type.

Preferably, the powder comprises least 40%, 50%, 60%, 70%, 80%, 90% or 95% by weight of polyamide and/or copolyamide, with respect to the total weight of the powder. Preferably also, the powder comprises at most 95%, 90%, 80%, 70%, 60% or 50% by weight of polyamide and/or copolyamide, with respect to the total weight of the powder.

The powder can alto comprise at least one other polymer. Mention may be made, as examples of this other polymer, of polyolefins, polyesters, polycarbonate, PPO (abbreviation for polyphenylene oxide), PPS (abbreviation for polyphenylene sulfide) of elastomers. In a specific embodiment of the invention, the powder according to the Invention does not comprise other polymer than polyamide and/or copolyamide according to the invention.

Preferably, the powder according to the invention comprises at least one other in particular selected from the group consisting of a synergist of the flame-retardant agent of cyclic phosphonate ester type, of a pigment, of a dye, of a plasticizer, of an antioxidant, of a pourability agent and of a UV absorption agent.

Preferably, the synergist of the flame-retardant agent of cyclic phosphonate ester type is selected from the group consisting of aluminum diethylphosphinate (ALDEP), melamine cyanurate, pyrophosphate, red phosphorus, phosphates, melamine polyphosphate and ammonium polyphosphate.

In one embodiment of the invention, the powder according to the invention does not comprise synergist of the flame-retardant agent of cyclic phosphonate ester type.

It has been observed that the powder of the present invention exhibits a good recyclability, in particular when it prepared by a dry blending process. Thus, the invention makes it possible to recycle the powder not converted into a part subsequent to a 3D printing, namely to reuse the unconverted powder in a subsequent 3D printing process, in, order to obtain flame-retarded objects with reproducible mechanic al properties and flame-retardant properties.

According to one aspect the invention relates to a process for the preparation of flame-retarded parts by powder bed fusion, in particular by 3D printing more particularly by 3D printing by laser sintering, using a recycled powder as defined above.

### Flame-Retarded Pit

The flame-retarded part according to the invention can be of any type capable of being produced by powder bed fusion, in particular by 3D printing, more particularly by 3D printing by laser sintering:

Advantageously, the powder according to the invention is such that it makes it possible to obtain parts categorized as V-2, more advantageously V-1 and more advantageously still V-0 according to the standards UL 94 V and IEC 60695-11-10, in particular described in the examples.

### DESCRIPTION OF THE FIGURES

FIG. 1 is a photograph of a part obtained by 3D printing starting from a powder according to the invention.

FIG. 2 is a photograph of a part obtained by 3D printing starting from a comparative powder.

The invention will be further clarified, in a nonlimiting way, using the examples and figures which follow.

### EXAMPLE

### Example 1

A powder according to the Invention is produced by dry blending (using a Henschel blender) 33% by weight with respect to the total weight of the powder, of polyamide 11 (Rilsan Invent Natural (RIN), Arkema) and 17% by weight with respect to the total weight of the powder, of flame-retardant agent of cyclic phosphonate ester type of following formula (III):

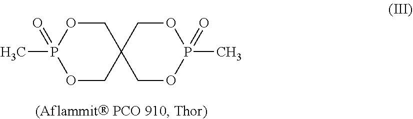

A comparative powder is produced which comprises 80% by weight with respect to the total weight of the powder, of polyamide 11 (Rilsan Invent Natural (RIN), Arkema) and 20% by weight with respect to the total weight of the powder, of flame-retardant agent of melamine polyphosphate type (Melapur™ 200, BASF).

The powders are used to feed a Formiga® P100 (Eos) 3D printer and to print a part of bartype having the following dimensions: length 127 mm, width 12.7 mm and thickness 2.5 mm.

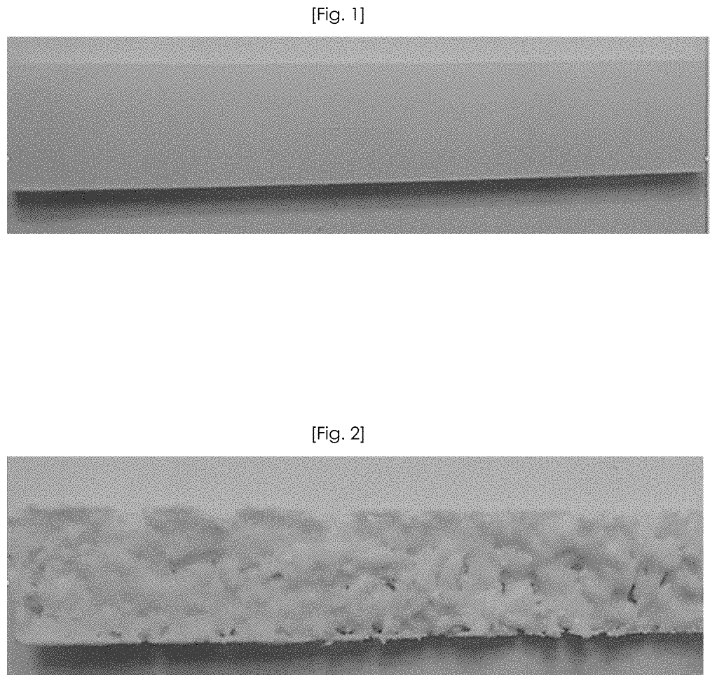

Photographs of the parts obtained are presented in FIG. 1 (powder according to the invention) and in FIG. 2 (comparative powder).

It is observed that while the powder according to the Invention makes it possible to obtain a perfectly smooth part the part obtained with the comparative powder exhibits coalescence problems. The comparative powder is thus unsuitable for use for 3D printing.

### Example 2

Tests were carried out with a commercial flame-retardant agent Technirez® FR-001, exhibiting a viscous liquid appearance, which has the same molecule as the flame-retardant agent Antiblaze 1045®.

Test 1: The flame-retardant agent Technirez® FR-001 was introduced into the polyamide powder by means of a Henschel blender.

A very fluffy powder is obtained. It is impossible to use it in the 3D printing machine, i.e. the part sintering could not be carried out.

Test 2: The flame-retardant agent Technirez® FR-001 is preheated at 70° C. before introducing it into a Henschel blender with the polyamide powder with stirring.

A very fluffy powder is obtained. It is impossible to use it in the 3D printing machine, i.e. the part sintering could not be carried out.

### Example 3

The part obtained from the powder according to the invention as defined in example 1 was tested according to the standard UL 94V.

Briefly, according to this standard, the length of the sample is 127 mm and its width is 12.7 mm. Its thickness must not exceed 12.7 mm. The sample is fixed at ¼ from its upper end in the vertical position. A metal net covered with absorbent cotton is positioned at 305 mm under the sample. The burner is adjusted in order form a blue flame of 19 mm which rises in temperature from 100 to 700° C. in 44±2 seconds. This flame is directed from below over the lower edge of the plastic sample at a distance of 9.5 mm. It is applied for 10 seconds then removed. The combustion time of the sample is measured. As soon as combustion has halted, the flame is reapplied fir 10 seconds, immediately removed, the combustion time and the glowing time are again measured. The complete test is carried out on five samples.

The material tested is classified UL 9.4 V-0 if:

A) NO of the five samples burns for more than 10 seconds after the flame of the burner has been removed.

B) The total combustion time over the 10 tests does not exceed 50 seconds.

C) None of the samples tested burns, either with a flame Or by incandescence, as far as the holding jaw

D) No blowing drop, which can ignite the cotton cloth placed below, falls from any sample.

E) No sample exhibits a glowing time exceeding 30 seconds.

The material tested is classified as LI 94 V-1 if:

A) None of the five samples burns for more than 30 seconds after the flame of the burner has been removed.

B) The total combustion time over the 10 tests does not exceed 250 seconds.

C) None or the samples tested burns, either with a flame or by incandescence, as far as the holding jaw.

D) No glowing drop, which can ignite the cotton cloth placed below, falls from any sample.

E) No sample exhibits a glowing time exceeding 60 seconds.

The material tested is classified as UL 94 V-2 if:

A) None of the five samples burns for more than 30 seconds after the flame of the burner has been removed.

B) The total combustion time over the 10 tests does not exceed 250 seconds.

C) None of the samples tested burns, either with a flame or by incandescence, as far as the holding jaw.

D) A few fragments may become detached from the sample tested burning temporarily, and some of which may ignite the cotton cloth placed below.

E) No sample exhibits a glowing time exceeding 60 seconds.

Results of tests according to the standard UL 94 V: The part according to the invention is classified V-0 according to the standard UL 94 measured with a thickness of 1.3 mm on the samples.

By comparison, a part with the same dimensions obtained with the powder FR-106 (Advanced Laser Materials, ALM) of flame-retarded polyamide for 3D printing based on PA 11 (PA D80-ST, ALM) and comprising a flame-retardant agent of brominated polyacrylate type (FR-1025, ALM) was tested and is classified as V-2 according to the standard UL 94, measured with a thickness of 2.5 mm on the samples.

The mixture according to the invention is suitable for obtaining parts of good quality in 3D printing while conferring on them a flame retardancy equivalent to or superior to that obtained according to the state of the art.

### Example 4

In addition, the mechanical properties of maximum stresses and of elongation at break of the parts obtained using the powder according to the invention are equivalent to those of parts obtained with the comparative powder FR-106 comprising a halogenated flame-retardant agent. An improvement in the Young's modulus, measured according to the standard ISO 527-2: 2012-1A is even noted, with per in 2000 MPa for the parts of the invention versus 1750 for the parts Obtained with the comparative powder FR-106.

The present invention thus provides a powder devoid of halogenated additives, which is easy to prepare and to use in 3D machines, making it possible to manufacture a part having a better flame-retardant property while retaining the mechanical properties.

1. A process for the preparation of flame-retarded parts by powder bed fusion, in which the powder comprises at least one polyamide and/or copolyamide and at least one flame-retardant agent of cyclic phosphonate ester type, in which the flame-retardant agent of cyclic phosphonate ester type is of general formula (I): 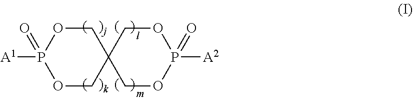
in which:
j, k, l and m, which are identical or different, represent an integer from 1 to 3;
A¹ and A², which are identical or different, represent an alkyl group of 1 to 4 carbon atoms or an aryl group of 5 to 7 carbon atoms.

2. The process as claimed in claim 1, in which the process is a 3D printing process and the powder is a powder for 3D printing.

3. The process as claimed in claim 1, in which the process is a process for 3D printing by laser sintering of the powder.

4. The process as claimed in claim 1, in which the polyamide is selected from the group consisting of polyamide 6 (PA 6), polyamide 66 (PA 66), polyamide 610 (PA 610), polyamide 612 (PA 612), polyamide 11 (PA 11) and polyamide 12 (PA 12).

5. The process as claimed in claim 1, in which the polyamide is PA 11.

6. The process as claimed in claim 1, in which the flame-retardant agent of cyclic phosphonate ester type is of general formula (II): 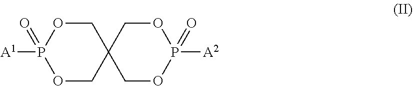
in which A¹ and A², which are identical or different, represent an alkyl group of 1 to 4 carbon atoms or an aryl group of 5 to 7 carbon atoms.

7. The process as claimed in claim 1, in which the flame-retardant agent of cyclic phosphonate ester type is of following formula (III):

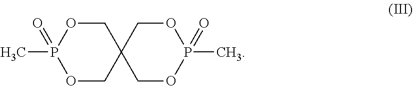

8. The process as claimed in claim 1, in which the powder comprises from 5% to 40% by weight, with respect to the total weight of the powder, of the flame-retardant agent of cyclic phosphonate ester type.

9. The process as claimed in claim 1, in which the powder comprises at least 50% by weight of polyamide and/or copolyamide, with respect to the total weight of the powder.

10. The process as claimed in claim 1, in which the powder comprises at least one other additive selected from the group consisting of a synergist of the flame-retardant agent of cyclic phosphonate ester type, of a pigment, of a dye, of a plasticizer, of an antioxidant, of a pourability agent and of a UV absorption agent.

11. A powder intended for the preparation of flame-retarded parts by powder bed fusion, comprising at least one polyamide and/or copolyamide, and at least one flame-retardant agent of cyclic phosphonate ester type, in which the flame-retardant agent of cyclic phosphonate ester type is of general formula (I): 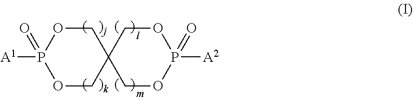
in which:
j, k, l and m, which are identical or different, represent an integer from 1 to 3;
A¹ and A², which are identical or different, represent an alkyl group of 1 to 4 carbon atoms or an aryl group of 5 to 7 carbon atoms.

12. The powder as claimed in claim 11, wherein the powder is configured for a 3D printing process.

13. The powder as claimed in claim 11, in which the flame-retardant agent of cyclic phosphonate ester type is of general formula (II): 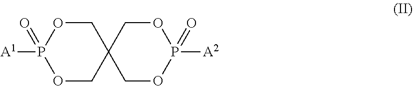
in which A¹ and A², which are identical or different, represent an alkyl group of 1 to 4 carbon atoms or an aryl group of 5 to 7 carbon atoms

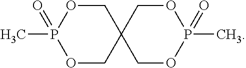

14. The powder as claimed in claim 11, in which the powder comprises from 5% to 40% by weight, with respect to the total weight of the powder, of the flame-retardant agent of cyclic phosphonate ester type.

15. The powder as claimed in claim 11, in which the powder comprises at least 50% by weight of polyamide and/or copolyamide, with respect to the total weight of the powder.

16. The powder as claimed in claim 11, in which the powder comprises at least one other additive selected from the group consisting of a synergist of the flame-retardant agent of cyclic phosphonate ester type, of a pigment, of a dye, of a plasticizer, of an antioxidant, of a pourability agent and of a UV absorption agent.

17. The use of a powder as defined in claim 11, in a powder bed fusion process, in order to produce a flame-retarded part.

18. A process for the preparation of a powder as defined in claim 11, comprising the blending of at least one polyamide and/or copolyamide and of at least one flame-retardant agent of cyclic phosphonate ester type, in which the flame-retardant agent of cyclic phosphonate ester type is of general formula (I): 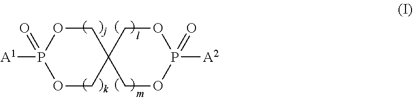
in which:
j, k, l and m, which are identical or different, represent an integer from 1 to 3;
A¹ and A², which are identical or different, represent an alkyl group of 1 to 4 carbon atoms or an aryl group of 5 to 7 carbon atoms.

19. The process as claimed in claim 18, in which the blending is carried out by dry blending.
